(19) United States
(12) Patent Application Publication
(10) Pub. No.: US 2024/0085090 A1
(43) Pub. Date: Mar. 14, 2024

(54) AUTOMATIC DOOR OPENING AND CLOSING DEVICE FOR REFRIGERATOR AND REFRIGERATOR HAVING THE SAME

(71) Applicants: QINGDAO HAIER REFRIGERATOR CO., LTD., Qingdao City, Shandong Province (CN); HAIER SMART HOME CO., LTD., Qingdao City, Shandong Province (CN)

(72) Inventors: JIANLIN MIAO, Qingdao City, Shandong Province (CN); YIHAO XU, Qingdao City, Shandong Province (CN); XUELI CHENG, Qingdao City, Shandong Province (CN); MING WANG, Qingdao City, Shandong Province (CN)

(21) Appl. No.: 18/270,199

(22) PCT Filed: Oct. 29, 2021
(86) PCT No.: PCT/CN2021/127660

§ 371 Date: Jun. 28, 2023

(30) Foreign Application Priority Data
Dec. 31, 2020 (CN) 202011637629.9

(51) Int. Cl. F25D 23/02; E05F 15/616; E05F 15/70

(52) U.S. Cl. CPC F25D 23/028; E05F 15/616; E05F 15/70; E05Y 2900/31

(57) ABSTRACT

The automatic door opening and closing device includes: a housing having a mounting space formed therein; and a pushing and rotating assembly provided in the mounting space and having a push rod controlled to be telescopic and a guide rod which extends outwards from the mounting space and is controlled to be movable; wherein the push rod is configured to push open a door of the refrigerator when controlled to extend, and the guide rod is configured to drive the door of the refrigerator to rotate after the push rod pushes open the door of the refrigerator. By integrating the push rod and the guide rod in the mounting space inside the housing.

### TECHNICAL FIELD

The present invention relates to a refrigeration apparatus, and in particular, to an automatic door opening and closing device for a refrigerator and a refrigerator having the same.

### BACKGROUND

In daily life, a user manually opens and closes a door of a refrigerator to implement article taking and placing actions.

In order to improve an automation degree of the door opening and closing process, a door opening and closing mechanism can be mounted on the refrigerator. Since a plurality of acting forces, such as a door gasket suction force, or the like, are required to be overcome to do work in the door opening and closing process, a plurality of different door opening and closing mechanisms are often required to jointly act to smoothly open and close the door, such that the door opening and closing mechanisms are miscellaneous, an overall structure is complex, integration is poor, an occupied space is large, and a mounting space for each mechanism is required to be reserved in a foaming process, resulting in a complex foaming process.

Therefore, provision of a new automatic door opening and closing device to simplify the structure of the door opening and closing mechanism and improve the integration becomes a technical problem to be urgently solved by those skilled in the art.

### SUMMARY

An object of the present invention is to provide an automatic door opening and closing device for a refrigerator and a refrigerator having the same, which solve at least one of the above-mentioned technical problems.

A further object of the present invention is to provide a new automatic door opening and closing device which simplifies a structure of a door opening and closing mechanism and improves integration.

Another object of the present invention is to provide a new beam turnover method which reduces turnover difficulty of a turnover beam.

Another object of the present invention is to improve an automation of a door opening and closing process.

According to an embodiment of the present invention, An automatic door opening and closing device for a refrigerator, comprising:
a housing having a mounting space formed therein; and
a pushing and rotating assembly provided in the mounting space and having a push rod controlled to be retractable and a guide rod which extends outwards from the mounting space and is controlled to be movable; wherein the push rod is configured to push open a door of the refrigerator when controlled to extend, and the guide rod is configured to drive the door of the refrigerator to rotate after the push rod pushes open the door of the refrigerator.

According to an embodiment of the present invention, wherein the pushing and rotating assembly comprises at least one driving mechanism, and the driving mechanism comprises:
a driving motor; and
a transmission assembly connected with an output shaft of the driving motor and the push rod or the guide rod and configured to transmit a driving force provided by the driving motor to the push rod or the guide rod, such that the push rod is controllably extended and retracted, or the guide rod is controllably moved.

According to an embodiment of the present invention, wherein two driving mechanisms are provided, one driving mechanism is connected with the push rod and configured to drive the push rod to extend and retract, and the other driving mechanism is connected with the guide rod and configured to drive the guide rod to move.

According to an embodiment of the present invention, wherein the guide rod comprises:
a first guide portion having a first end fixedly connected to the driving mechanism and a second end outwards extending from the mounting space; and
a second guide portion having a first end relatively rotatably connected to the second end of the first guide portion and a second end fixedly connected to the door of the refrigerator.

According to an embodiment of the present invention, wherein the guide rod comprises: wherein the second end of the first guide portion is provided with a first assembling hole penetrating in a thickness direction thereof, and the first end of the second guide portion is provided with a second assembling hole penetrating in a thickness direction thereof;
the guide rod further comprises a rotating shaft portion having:
a rotation guide shaft assembled to the first assembling hole and the second assembling hole; and
an upper limit flange and a lower limit flange fixedly connected with the rotation guide shaft or integrated with the rotation guide shaft, and formed by outward radial extension from an upper section and a lower section of the rotation guide shaft respectively, such that the first guide portion and the second guide portion are relatively rotatably fitted over the rotation guide shaft.

According to an embodiment of the present invention, wherein the push rod is configured to controllably extend or retract along a direction of a central axis thereof, and the central axis of the push rod is parallel to a front-rear extending direction of the refrigerator; a rack arranged along the direction of the central axis of the push rod is formed on the push rod and configured to be in meshed connection with the driving mechanism.

According to an embodiment of the present invention, wherein the housing has a front wall and a back wall arranged opposite to each other, and the front wall is provided with a retractable hole in which the push rod is inserted and is retractably movable;
the pushing and rotating assembly further comprises:
a return elastic element connected between the back wall of the housing and the push rod and configured to drive the push rod to be retracted after the push rod is controllably extended.

According to an embodiment of the present invention, a turnover assembly provided outside the housing and comprising:
a turnover beam configured to be connected to the door of the refrigerator rotatably; and
a beam turnover mechanism comprising a turnover elastic assembly provided on the door of the refrigerator in a mode of reciprocating rotation around a shaft; wherein the turnover elastic assembly is configured to generate compression deformation by rotating around a shaft in a process of opening the door of the refrigerator, and release an elastic force by reversely rotating around the shaft to recover from the compression deformation in a process of closing the door of the refrigerator, such that the door of the refrigerator is driven to be closed, and the turnover beam is driven to be turned over in the process of closing the door of the refrigerator.

According to an embodiment of the present invention, wherein the beam turnover mechanism further comprises:
a cabinet fixed plate configured to be fixedly connected with a cabinet of the refrigerator; and
a turnover fixed shaft fixed above the cabinet fixed plate along a vertical direction; the turnover fixed shaft having an upper shaft section, a middle shaft section and a lower shaft section which are sequentially arranged from top to bottom; a rotating wheel radially extending outwards from the middle shaft section; an outer circumferential surface of the rotating wheel being provided with a wheel pit radially recessed inwards; and
the turnover elastic assembly comprises:
an elastic assembly assembling box having a plurality of assembling sections, the plural assembling sections comprising a first assembling section, a second assembling section and a third assembling section which are sequentially arranged along a horizontal direction, and the first assembling section being rotatably fitted over the upper shaft section and the lower shaft section, such that the turnover elastic assembly performs reciprocating rotation around the turnover fixed shaft; a guide shaft capable of reciprocating along an arrangement direction of the plural assembling sections being provided in the second assembling section; the third assembling section forming a retractable space;
   a turnover elastic element retractably provided in the retractable space along the arrangement direction of the plural assembling sections and fixedly connected with the guide shaft; the guide shaft being provided with a protrusion matched with the wheel pit in shape, and the protrusion being configured to leave the wheel pit in the opening process of the door of the refrigerator, such that the turnover elastic element generates compression deformation; the protrusion being further configured to enter the wheel pit in the closing process of the door of the refrigerator, such that the turnover elastic element recovers from the compression deformation to release the elastic force.

According to an embodiment of the present invention, provided a refrigerator comprising: a case; a door body, pivotally connected to the case, and an automatic door opening and closing device for the refrigerator as described in any of the foregoing.

The present invention discloses an automatic door opening and closing device for a refrigerator and a refrigerator having the same; the automatic door opening and closing device includes a housing and a pushing and rotating assembly provided in a mounting space in the housing, and the pushing and rotating assembly includes a push rod controlled to be retracted and a guide rod which extends outwards from the mounting space and is controlled to be movable. The push rod is configured to push open a door of the refrigerator when controlled to extend, and the guide rod is configured to drive the door of the refrigerator to rotate after the push rod pushes open the door of the refrigerator. By integrating the push rod and the guide rod in the mounting space inside the housing, the present invention provides a new automatic door opening and closing device, which not only reduces a number of the door opening and closing mechanisms, simplifies an overall structure of the door opening and closing mechanisms, but also improves the integration of the whole device, does not need to occupy a too large space, and reduces foaming difficulty.

Further, a new beam turnover mechanism and a beam turnover method are provided in the automatic door opening and closing device for a refrigerator and the refrigerator having the same according to the present invention. The beam turnover mechanism has a turnover elastic assembly which is configured to generate compression deformation by rotating around a shaft in a process of opening the door of the refrigerator, and release an elastic force by reversely rotating around the shaft to recover from the compression deformation in a process of closing the door of the refrigerator, such that the door of the refrigerator is driven to be closed, and the turnover beam is driven to be turned over in the process of closing the door of the refrigerator. By utilizing the beam turnover mechanism to assist rotation of the door, the door can rotate towards a closed position under double actions of the pushing and rotating assembly and the turnover elastic assembly, which can indirectly provide turnover power for the turnover beam to indirectly promote the turnover beam to accomplish a turnover, thus reducing the turnover difficulty of the turnover beam.

Still further, in the automatic door opening and closing device for a refrigerator and the refrigerator having the same according to the present invention, a door opening and closing action can be completed only by controlling the push rod and/or the guide rod of the pushing and rotating assembly in the door opening and closing process, such that the automation of the door opening and closing process is improved, and a control process is simple.

The above and other objects, advantages and features of the present invention will become more apparent to those skilled in the art from the following detailed description of specific embodiments thereof taken in conjunction with the accompanying drawings.

### BRIEF DESCRIPTION OF THE DRAWINGS

Some specific embodiments of the invention will be described in detail hereinafter by way of example and not by way of limitation with reference to the accompanying drawings. The same reference numerals identify the same or similar components or parts in the drawings. Those skilled in the art should appreciate that the drawings are not necessarily drawn to scale. In the drawings:

FIG. 1 is a schematic diagram of a refrigerator according to an embodiment of the present invention;

FIG. 2 is a schematic diagram of an automatic door opening and closing device for a refrigerator according to an embodiment of the present invention;

FIG. 3 is a top view of the automatic door opening and closing device shown in FIG. 2;

FIG. 4 is a structural view of a housing and a pushing and rotating mechanism of the automatic door opening and closing device shown in FIG. 2;

FIG. 5 is a partial structural view of a guide rod of the pushing and rotating mechanism of the automatic door opening and closing device shown in FIG. 2;

FIG. 6 is a schematic diagram of a beam turnover mechanism of the automatic door opening and closing device shown in FIG. 2;

FIG. 7 is an exploded view of the beam turnover mechanism of the automatic door opening and closing device shown in FIG. 6;

FIG. 8 is a further exploded view of the beam turnover mechanism of the automatic door opening and closing device shown in FIG. 7;

FIG. 9 is a schematic diagram of a turnover fixed shaft in the beam turnover mechanism of the automatic door opening and closing device shown in FIG. 8; and

FIG. 10 is a schematic diagram of a turnover elastic assembly in the beam turnover mechanism of the automatic door opening and closing device shown in FIG. 8.

### DETAILED DESCRIPTION

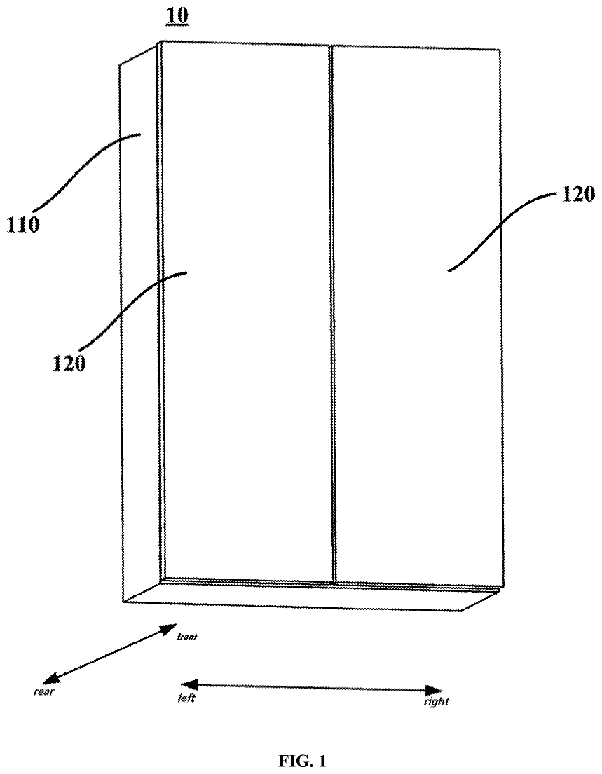

FIG. 1 is a schematic diagram of a refrigerator 10 according to an embodiment of the present invention. The refrigerator 10 may generally include a cabinet 110, a door 120, and an automatic door opening and closing device. The automatic door opening and closing device may generally include a housing 230 and a pushing and rotating assembly provided in a mounting space inside the housing 230, and may further include a turnover assembly provided outside the housing 230.

The automatic door opening and closing device according to the present embodiment may be applied to various types of refrigerators 10, such as a single-door refrigerator or a multi-door refrigerator, and is particularly applicable to a refrigerator 10 having at least two doors 120 with opposite opening directions, such as a side-by-side refrigerator, a cross-door refrigerator, a French multi-door refrigerator, or the like. A side-by-side refrigerator is taken as an example in the following description, an automatic door opening and closing device suitable for the side-by-side refrigerator is illustrated, and those skilled in the art should be fully capable of expanding to other applications based on the understanding of the present embodiment, which are not illustrated one by one.

A storage compartment may be formed in the cabinet 110, and may be configured as a storage space having a forward opening. The door 120 is pivotally provided on the cabinet 110 to close or open the forward opening, so as to close or open the storage compartment. Two doors 120 may be provided in the present embodiment, and arranged at the forward opening in a mirror symmetry mode; for example, the first door 120 may be configured to close a left half of the forward opening, and the second door 120 may be configured to close a right half of the forward opening. Opening directions of the two doors 120 are opposite; for example, a pivot shaft of the first door 120 may be located on a left side thereof, and a pivot shaft of the second door 120 may be located on a right side thereof. The arrows in the drawings show left and right directions, and words, such as “left”, “right”, or the like, used for indicating orientations are all relative to an actual usage state of the refrigerator 10, and may be substantially a horizontal transverse extending direction of the cabinet 110. Each door 120 has a closed position and an open position. When the door 120 is at the closed position, the door 120 closes the forward opening of the cabinet 110, and when the door 120 rotates from the closed position to the open position, the door 120 opens the forward opening of the cabinet 110.

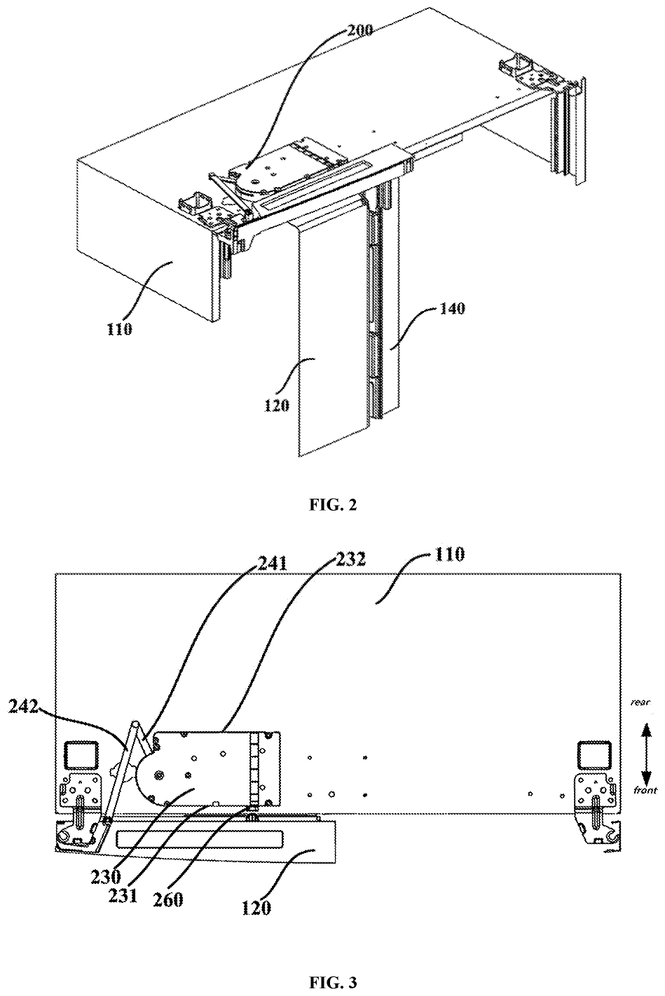

FIG. 2 is a schematic diagram of the automatic door opening and closing device for the refrigerator 10 according to an embodiment of the present invention, which is configured to drive the first door 120 to be opened and closed. An automatic door opening and closing device for driving the second door 120 to be opened and closed is omitted in the drawing, and FIG. 2 also shows a part of the door 120 and a part of the cabinet 110 of the refrigerator 10 for the convenience of observation of a mounting position of the automatic door opening and closing device.

The housing 230 of the automatic door opening and closing device is configured to accommodate the pushing and rotating assembly. The housing 230 may have a substantially rectangular parallelepiped shape, or any other shape. The mounting space is formed inside the housing 230. The pushing and rotating assembly is provided in the mounting space. That is, the pushing and rotating assembly is integrally provided on the housing 230. The housing 230 may be provided above the cabinet 110 near a top of the door 120, so as to apply an acting force to the door 120.

FIG. 3 is a top view of the automatic door opening and closing device shown in FIG. 2, and FIG. 3 also shows a part of the door 120 and a part of the cabinet 110 of the refrigerator 10 for the convenience of observation of a relative position between the automatic door opening and closing device and the door 120.

The pushing and rotating assembly has a push rod 260 controlled to be retracted and a guide rod which extends outwards from the mounting space and is controlled to be movable. The push rod 260 is configured to push open the door 120 of the refrigerator 10 when controlled to extend, and the guide rod is configured to drive the door 120 of the refrigerator 10 to rotate after the push rod 260 pushes open the door 120 of the refrigerator 10. The push rod 260 may have a substantially long rod shape. The guide rod may substantially have a link shape.

When the door 120 is located at the closed position, a door gasket of the refrigerator 10 functions to seal the door 120 and the cabinet 110. In the process of driving the door 120 to rotate to the open position, the door 120 is first pushed open by the push rod 260, such that the door 120 overcomes a suction force of the door gasket. After the push rod 260 pushes the door 120 open, the guide rod guides the door 120 to rotate, such that the door 120 can rotate to the open position.

By integrating the push rod 260 and the guide rod in the mounting space inside the housing 230, the present embodiment provides a new automatic door opening and closing device, which not only reduces a number of door opening and closing mechanisms, simplifies an overall structure of the door opening and closing mechanisms, but also improves integration of the whole device, does not need to occupy a too large space, and reduces foaming difficulty.

In the refrigerator 10 according to the present embodiment, by improving structures and moving modes of the push rod 260 and the guide rod, an opening and closing action can be completed only by controlling the push rod 260 and/or the guide rod of the pushing and rotating assembly in a door opening process, such that an automation degree of the opening and closing process of the door 120 is improved, and a control process is simple.

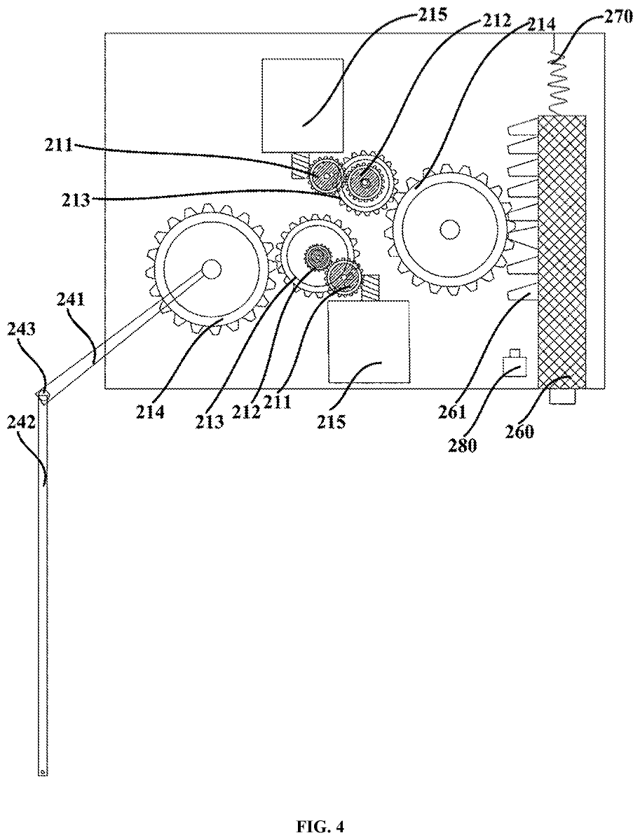

FIG. 4 is a structural view of the housing 230 and a pushing and rotating mechanism 200 of the automatic door opening and closing device shown in FIG. 2.

The pushing and rotating assembly further includes at least one driving mechanism provided in the mounting space. The driving mechanism includes a driving motor 215 and a transmission assembly. That is, one driving mechanism has one driving motor 215 and one transmission assembly. The driving motor 215 may be configured as a stepper motor and the transmission assembly may be configured as a gear set. The driving motor 215 is configured to provide a driving force for the push rod 260 and the guide rod of the pushing and rotating assembly, and the transmission assembly is connected with an output shaft of the driving motor 215 and the push rod 260 or the guide rod and configured to transmit the driving force provided by the driving motor 215 to the push rod 260 or the guide rod, such that the push rod 260 is controllably extended and retracted, or the guide rod is controllably moved.

Two driving mechanisms may be provided in the present embodiment, and each driving mechanism has one driving motor 215 and one transmission assembly. The two driving mechanisms cannot interfere with each other. One driving mechanism is connected with the push rod 260 and configured to drive the push rod 260 to extend and retract; for example, the transmission assembly of the driving mechanism may be connected with the output shaft of the corresponding driving motor 215 and the push rod 260, and the driving mechanism can be named as a first driving mechanism. The other driving mechanism is connected with the guide rod and configured to drive the guide rod to move; for example, the transmission assembly of the driving mechanism may be connected with the output shaft of the corresponding driving motor 215 and the guide rod, and the driving mechanism can be named as a second driving mechanism.

In a left-right extending direction of the cabinet 110 of the refrigerator 10, the push rod 260 may be provided on a right side of the guide rod near a portion where the door 120 is connected with a turnover beam 140, so as to push the door 120 open with a small acting force.

The push rod 260 is configured to controllably extend or retract along a central axis direction thereof, and a central axis of the push rod 260 is parallel to a front-rear extending direction of the refrigerator 10. The arrows in FIG. 1 show the front-rear extending direction of the cabinet 110, and words, such as “front”, “rear”, or the like, used for indicating orientations are all relative to the actual usage state of the refrigerator 10.

A rack 261 arranged along the central axis direction of the push rod 260 is formed on the push rod 260, and configured to be in meshed connection with a driving mechanism, and the driving mechanism here may refer to the transmission assembly of the first driving mechanism, such that the transmission assembly of the first driving mechanism transmits the driving force of the driving motor 215 of the first driving mechanism to the push rod 260.

The housing 230 may have a front wall 231 and a back wall 232 arranged opposite to each other, and the front wall 231 is provided with a retracted hole in which the push rod 260 is inserted and is retractably movable. The push rod 260 may extend forwards through the retracted hole to push the door 120 open. The pushing and rotating assembly may further include a return elastic element 270 connected between the back wall 232 of the housing 230 and the push rod 260. That is, the return elastic element 270 is provided on a rear side of the push rod 260 in the central axis direction of the push rod 260, and has one end fixedly connected with the push rod 260 and the other end fixedly connected with a rear wall of the housing 230. A telescopic direction of the return elastic element 270 is collinear with the central axis direction of the push rod 260. The return elastic element 270 is configured to drive the push rod 260 to be retracted after the push rod 260 is controllably extended, so as to prevent the push rod 260 from interfering with the closing process of the door 120. The return elastic element 270 may be configured as any elastic body having a telescopic performance, for example, but not limited to, a spring. In the process that the push rod 260 extends forwards to push the door 120 open, the return elastic element 270 is stretched and deformed.

In some embodiments, the pushing and rotating assembly may further include a proximity sensor 280 provided on a front side of the rack 261 of the push rod 260. When the push rod 260 extends, the rack 261 thereof moves forwards therewith. When the rack 261 of the push rod 260 is pressed against the proximity sensor 280, the proximity sensor 280 may generate a specific electric signal, and the driving motor 215 of the first driving mechanism may be switched to a standby state after receiving the electric signal of the proximity sensor 280.

The guide rod may be located on a left side of the push rod 260 and provided near the pivot shaft of the door 120, so as to apply an acting force to the pivot shaft of the door 120. The guide rod may be substantially in a link structure. The guide rod may include a first guide portion 241 and a second guide portion 242 connected to each other and relatively rotatable, and may further include a rotating shaft portion 243 for connecting the first guide portion 241 and the second guide portion 242. Each of the first guide portion 241 and the second guide portion 242 may have a rod shape. Each guide portion has a first end and a second end along a length direction thereof.

The first guide portion 241 has a first end fixedly connected to a driving mechanism, which may refer to the transmission assembly of the second driving mechanism, and a second end outwardly extending from the mounting space. The second guide portion 242 has a first end relatively rotatably connected to the second end of the first guide portion 241 and a second end fixedly connected to the door 120 of the refrigerator 10. That is, the first end of the first guide portion 241 is located in the mounting space and configured to be in transmission connection with the transmission assembly of the second driving mechanism, and the second end of the first guide portion 241 extends to the outside of the mounting space and is configured to be relatively rotatably connected with the first end of the second guide portion 242. The second end of the second guide portion 242 is fixedly connected with the door 120 of the refrigerator 10, for example, may be fixedly connected to the pivot shaft of the door 120 by a hinge.

The first guide portion 241 and the second guide portion 242 may be located in the same horizontal plane and may relatively rotate in the horizontal plane. When the first guide portion 241 and the second guide portion 242 rotate relatively, an angle between the two guide portions changes. The second end of the first guide portion 241 is provided with a first assembling hole penetrating in a thickness direction thereof, and the first end of the second guide portion 242 is provided with a second assembling hole penetrating in a thickness direction thereof. The “thickness direction” here may refer to a vertical direction.

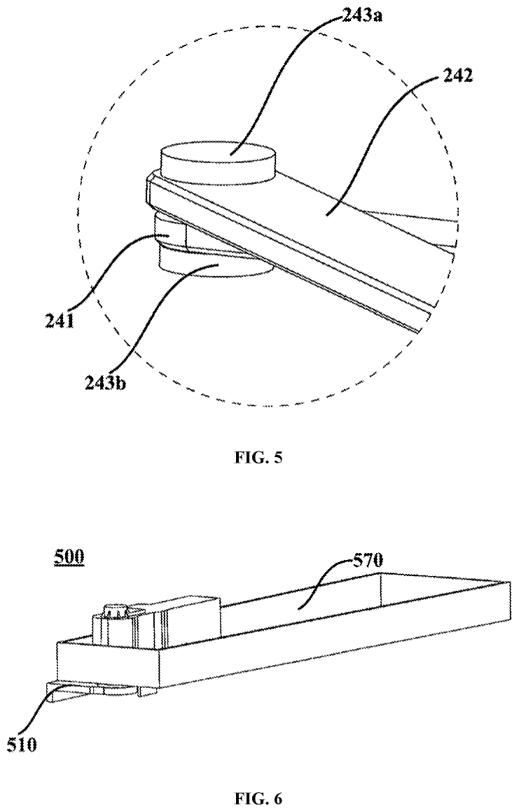

FIG. 5 is a partial structural view of the guide rod of the pushing and rotating mechanism 200 of the automatic door opening and closing device shown in FIG. 2.

The rotating shaft portion 243 has a rotation guide shaft, an upper limit flange 243a, and a lower limit flange 243b. A central axis of the rotation guide shaft, a central axis of the upper limit flange 243a, and a central axis of the lower limit flange 243b are coaxial and extend in the vertical direction. The upper limit flange 243a and the lower limit flange 243b may be substantially cylindrical. The rotation guide shaft is assembled to the first assembling hole and the second assembling hole. The first assembling hole and the rotation guide shaft can be fixedly or movably connected. The upper limit flange 243a and the lower limit flange 243b are fixedly connected with the rotation guide shaft or integrated with the rotation guide shaft, and are formed by outward radial extension from an upper section and a lower section of the rotation guide shaft respectively, such that the first guide portion 241 and the second guide portion 242 are relatively rotatably fitted over the rotation guide shaft. That is, the first guide portion 241 and the second guide portion 242 are fitted over the rotation guide shaft, and the upper limit flange 243a and the lower limit flange 243b have a cross-sectional diameter greater than a cross-sectional diameter of the rotation guide shaft, such that the first guide portion 241 and the second guide portion 242 can be prevented from being separated from the rotation guide shaft, which can improve reliability of the connection between the components of the guide rod.

The transmission assembly of the first driving mechanism and the transmission assembly of the second driving mechanism may have the same structure, and each of the transmission assemblies may include a first door transmission gear 211, a second door transmission gear 212, and a third door transmission gear 213.

The first door transmission gear 211 is connected to the output shaft of the corresponding driving motor 215. The first door transmission gear 211 may be in meshed connection with the output shaft of the driving motor 215, and the output shaft of the driving motor 215 may be provided with a rack meshed with teeth of the first door transmission gear 211. In some optional embodiments, the output shaft of the driving motor 215 may be connected to a shaft of the first door transmission gear 211.

The second door transmission gear 212 is meshed with the first door transmission gear 211. The third door transmission gear 213 is coaxial with the second door transmission gear 212 and in transmission connection with the push rod 260 or the guide rod. A position of the third door transmission gear 213 may be lower than a position of the second door transmission gear 212. A diameter of a root circle of the third door transmission gear 213 is greater than a diameter of a root circle of the second door transmission gear 212. That is, an overall external dimension of the third door transmission gear 213 is greater than an overall external dimension of the second door transmission gear 212, which can amplify a rotation of the driving motor 215, and the push rod 260 can be driven to generate a large telescopic amount by small-amplitude rotation, or the guide rod can be driven to generate a large rotation amount.

The transmission assembly of the door 120 in the present embodiment may further include a fourth door transmission gear 214 for transmission connection of the third door transmission gear 213 to the push rod 260 or the guide rod. That is, the third door transmission gear 213 can be in transmission connection with the push rod 260 or the guide rod through one fourth door transmission gear 214. For example, the fourth door transmission gear 214 can be in meshed connection with the third door transmission gear 213 on the one hand, and can be in meshed connection with the rack 261 of the push rod 260 on the other hand. For another example, on the one hand, the fourth door transmission gear 214 may be in meshed connection with the third door transmission gear 213, and on the other hand, a shaft of the fourth door transmission gear 214 may be fixedly connected with the first end of the first guide portion 241 of the guide rod.

By connection of the plurality of transmission gears of the transmission assembly, the automatic door opening and closing device according to the present embodiment can open and close the door 120 with a small driving force and a small motor rotation stroke, which facilitates a reduction of difficulty of opening and closing the door 120 by the automatic door opening and closing device.

In some optional embodiments, a number and a connection mode of the driving mechanisms of the pushing and rotating assembly may be varied. The pushing and rotating assembly may have one driving mechanism; that is, the pushing and rotating assembly may only have one driving motor 215 and one transmission assembly, and the driving motor 215 and the transmission assembly may simultaneously adjust movement of the push rod 260 and the guide rod, which may further simplify the structure of the automatic door opening and closing device and reduce a manufacturing cost.

For example, the connection mode between the driving motor 215 and the transmission assembly may not be changed, the transmission assembly still includes the first door transmission gear 211, the second door transmission gear 212, the third door transmission gear 213 and the fourth door transmission gear, and the connection mode between the plural door transmission gears may not be changed. On the one hand, the fourth door transmission gear 214 may be in meshed connection with the rack 261 of the push rod 260, and on the other hand, the shaft of the fourth door transmission gear 214 may be fixedly connected with the first end of the first guide portion 241 of the guide rod.

Since the push rod 260 plays a role of “pushing open the door” when extending, after the door 120 is pushed open, the push rod 260 is not required to extend continuously, and therefore, a length of the rack 261 of the push rod 260 can be substantially the same as an extension length of the push rod 260 when the door 120 is pushed open. When the door 120 is at the closed position, the fourth door transmission gear 214 can be meshed with a front end of the rack 261. The driving mechanism can also be provided with a limit switch which is configured to be turned on to limit a position of the push rod 260 to fix the push rod 260 when the rack 261 moves forwards and the fourth door transmission gear 214 is separated from the rack 261. At this point, the fourth door transmission gear 214 can only drive the guide rod to move continuously.

Since the fourth door transmission gear 214 is meshed with the rack 261 of the push rod 260 and fixedly connected with the guide rod, when the fourth door transmission gear 214 drives the push rod 260 to extend, the guide rod moves therewith, and the push rod 260 and the guide rod are driven to move simultaneously, thus reducing door opening difficulty. After the door 120 reaches the open position, the driving motor 215 may be switched to the standby state, and the limit switch may be turned off to release the limit of the push rod 260, such that the push rod can be driven by the return elastic element 270 to return to an original position.

The turnover assembly includes the turnover beam 140 and a beam turnover mechanism 500. The turnover beam 140 is configured to be connected to the door 120 of the refrigerator 10 rotatablely. For example, the turnover beam 140 may be connected to the first door 120 closing the left half of the forward opening in a turnover mode, a first end of the turnover beam 140 may be fixedly connected to a right edge portion of the first door 120, and a second end of the turnover beam 140 is opposite to the first end and rotates with the first end as a rotation axis, so as to overturn the turnover beam 140.

The turnover beam 140 and the door 120 may substantially have a plate shape. The turnover beam 140 can be turned over relative to the door 120 according to an opening-closing state of the door 120. When the door 120 is at the closed position, an angle between a plate surface where the turnover beam 140 is located and a plate surface where the door 120 is located may be substantially 0°, and in the process that the door 120 rotates from the closed position to the open position, the turnover beam 140 may rotate relative to the door 120, such that the angle between the plate surface where the turnover beam 140 is located and the plate surface where the door 120 is located may be substantially 90°, and at this point, the turnover beam 140 rotates relative to the door 120 to a turnover position; in the process that the door 120 rotates from the open position to the closed position, the turnover beam 140 may rotate again relative to the door 120, such that the included angle between the plate surface where the turnover beam 140 is located and the plate surface where the door 120 is located is changed to 0°, and at this point, the turnover beam 140 rotates relative to the door 120 to an extended position.

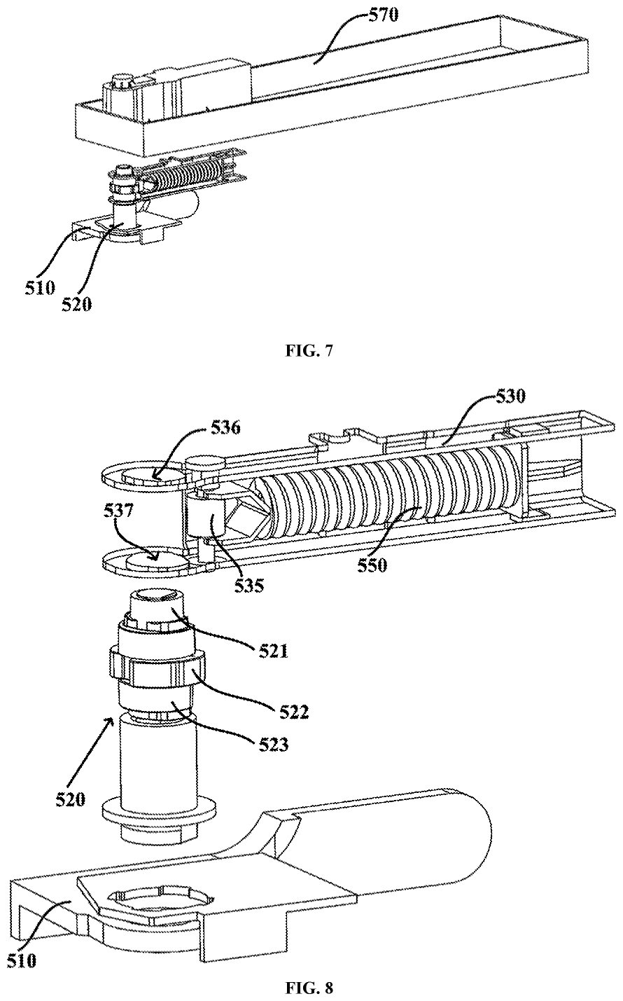

FIG. 6 is a schematic diagram of the beam turnover mechanism 500 of the automatic door opening and closing device shown in FIG. 2, FIG. 7 is an exploded view of the beam turnover mechanism 500 of the automatic door opening and closing device shown in FIG. 6, and FIG. 8 is a further exploded view of the beam turnover mechanism 500 of the automatic door opening and closing device shown in FIG. 7.

The beam turnover mechanism 500 includes a cabinet fixed plate 510, a turnover fixed shaft 520, and a turnover elastic assembly, and may further include a door fixing 570 fixedly connected with the door 120. The turnover elastic assembly is provided on the door 120 of the refrigerator 10 in a mode of reciprocating rotation around a shaft. The door 120 generally has a vertical plate surface. A part of a lower surface of the door 120 may be recessed upwards to form an accommodating cavity, and the accommodating cavity may be close to the pivot shaft of the door 120. The turnover elastic assembly can be provided in the accommodating cavity. For example, a body of the door fixing 570 may have a thin plate, a part of a plate surface thereof is recessed upwards to form an upward recess inserted into the accommodating cavity, and a space for mounting the turnover elastic assembly is defined in the upward recess. A third assembling section 533 of an elastic assembly assembling box 530 in the turnover elastic assembly may be fixedly connected with the upward recess. The door fixing element 570 is hidden in FIG. 8.

The turnover elastic assembly is configured to generate compression deformation by rotating around the shaft in the process of opening the door 120 of the refrigerator 10, and release an elastic force by reversely rotating around the shaft to recover from the compression deformation in the process of closing the door 120 of the refrigerator 10, such that the door 120 of the refrigerator 10 is driven to be closed, and the turnover beam 140 is driven to be turned over in the process of closing the door 120 of the refrigerator 10. That is, the turnover elastic assembly can “accumulate energy” by generating compression deformation in the opening process of the door 120, and “release energy” by recovering from the compression deformation in the closing process of the door 120, so as to provide a further driving force for closing of the door 120, such that the door 120 can rotate towards the closed position under the double actions of the pushing and rotating assembly and the turnover elastic assembly, which can indirectly provide turnover power for the turnover beam 140.

The cabinet fixed plate 510 is configured to be fixedly connected with the cabinet 110 of the refrigerator 10; for example, the plate surface of the body of the cabinet fixed plate 510 may be located below the accommodating cavity.

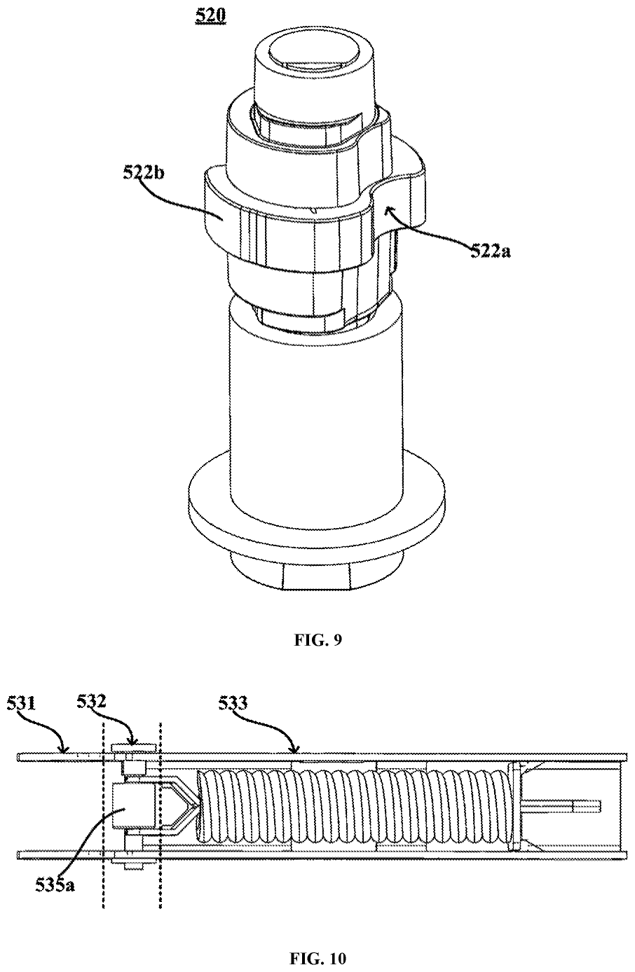

FIG. 9 is a schematic diagram of the turnover fixed shaft 520 in the beam turnover mechanism 500 of the automatic door opening and closing device shown in FIG. 8.

The turnover fixed shaft 520 is fixed above the cabinet fixed plate 510 in the vertical direction. In the present embodiment, the turnover fixed shaft 520 may extend into the accommodating cavity. The turnover fixed shaft 520 has an upper shaft section 521, a middle shaft section 522, and a lower shaft section 523 which are sequentially arranged from top to bottom. A rotating wheel radially extends outwards from the middle shaft section 522. A part of an outer circumferential surface of the rotating wheel forms a wheel surface portion 522b. The outer circumferential surface of the rotating wheel is also provided with a wheel pit 522a radially recessed inwards. That is, the wheel pit 522a is radially recessed inwards relative to the wheel surface portion 522b.

The turnover elastic assembly is rotatably fitted over the upper shaft section 521 and the lower shaft section 523. The turnover elastic assembly includes the elastic assembly assembling box 530 and a turnover elastic element 550 provided in the elastic assembly assembling box 530.

The elastic assembly assembling box 530 has a plurality of assembling sections including a first assembling section 531, a second assembling section 532, and a third assembling section 533 which are sequentially arranged in a horizontal direction. The first assembling section 531, the second assembling section 532, and the third assembling section 533 may be sequentially arranged from left to right when the door 120 is at the closed position. Each assembling section has opposite top and bottom walls.

FIG. 10 is a schematic diagram of the turnover elastic assembly of the beam turnover mechanism 500 of the automatic door opening and closing device shown in FIG. 8, in which a boundary line between the adjacent assembling sections is shown by a dotted line.

The first assembling section 531 is rotatably fitted over the upper shaft section 521 and the lower shaft section 523 to allow reciprocating rotation of the turnover elastic assembly around the turnover fixed shaft 520. The top wall of the first assembling section 531 may be provided with a third assembling hole 536 penetrating in a thickness direction thereof, and the bottom wall of the first assembling section 531 may be provided with a fourth assembling hole 537 penetrating in a thickness direction thereof and located below the first assembling hole. The third assembling hole 536 is rotatably fitted over the upper shaft section 521. The fourth assembling hole 537 is rotatably fitted over the lower shaft section 523.

A guide shaft 535 reciprocating in the arrangement direction of the plurality of assembling sections is provided in the second assembling section 532. The third assembling section 533 forms a telescopic space. A top wall of the second assembling section 532 may be provided with a first linear hole penetrating in a thickness direction thereof. A bottom wall of the second assembling section 532 may be provided with a second linear hole penetrating in a thickness direction thereof and located below a first telescopic hole. The guide shaft 535 may be inserted into the first linear hole and the second linear hole and reciprocate in the first linear hole and the second linear hole along a telescopic direction of the turnover elastic assembly 550.

The turnover elastic element 550 may be configured as any elastic body having a telescopic performance, for example, but not limited to, a spring. The turnover elastic element 550 is telescopically provided in the telescopic space along the arrangement direction of the plurality of assembling sections, and is fixedly connected with the guide shaft 535. The arrangement direction of the plurality of assembling sections is the telescopic direction of the turnover elastic element 550. The guide shaft 535 is provided with a protrusion 535a matched with the wheel pit 522a in shape, and the protrusion 535a radially extends outwards from a middle section of the guide shaft 535 and is located below the first linear hole above the second linear hole. The protrusion 535a is configured to leave the wheel pit 522a and rotate to the wheel surface portion 522b in the opening process of the door 120 of the refrigerator 10, such that the turnover elastic element 550 generates compression deformation, and the protrusion 535a is further configured to enter the wheel pit 522a in the closing process of the door 120 of the refrigerator 10, such that the turnover elastic element 550 recovers from the compression deformation to release the elastic force. That is, the door 120 drives the turnover elastic assembly to rotate around the turnover fixed shaft 520 in the rotation process, and the protrusion 535a moves along the circumferential surface of the rotating wheel in the rotation process of the turnover elastic assembly, so as to enter and exit from the wheel pit 522a.

The turnover elastic assembly is configured to rotate around the turnover fixed shaft 520 in the rotation process of the door 120, the turnover elastic element 550 is connected to the reciprocating guide shaft 535, and the protrusion 535a of the guide shaft 535 is fitted with the wheel pit 522a of the rotating wheel, such that compression and extension of the turnover elastic element 550 can be skillfully realized without directly providing a driving force for the turnover elastic element 550, and the turnover elastic element 550 can provide beam turnover power through compression and extension.

By integrating the push rod 260 and the guide rod in the mounting space inside the housing 230, the present embodiment provides a new automatic door opening and closing device, which not only reduces the number of the door 120 opening and closing mechanisms, simplifies the overall structure of the door 120 opening and closing mechanisms, but also improves the integration of the whole device, does not need to occupy a too large space, and reduces the foaming difficulty. By utilizing the beam turnover mechanism 500 to assist rotation of the door 120, the door 120 in the present embodiment can rotate towards the closed position under the double actions of the pushing and rotating assembly and the turnover elastic assembly, which can indirectly provide turnover power for the turnover beam 140 to indirectly promote the turnover beam 140 to accomplish a turnover action, thus reducing the turnover difficulty of the turnover beam 140.

So far, it should be appreciated by those skilled in the art that while various exemplary embodiments of the invention have been shown and described in detail herein, many other variations or modifications which are consistent with the principles of this invention may be determined or derived directly from the disclosure of the present invention without departing from the spirit and scope of the invention. Accordingly, the scope of the invention should be understood and interpreted to cover all such other variations or modifications.

1: An automatic door opening and closing device for a refrigerator, comprising:
a housing having a mounting space formed therein; and
a pushing and rotating assembly provided in the mounting space and having a push rod controlled to be retractable and a guide rod which extends outwards from the mounting space and is controlled to be movable; wherein the push rod is configured to push open a door of the refrigerator when controlled to extend, and the guide rod is configured to drive the door of the refrigerator to rotate after the push rod pushes open the door of the refrigerator.

2: The automatic door opening and closing device for a refrigerator according to claim 1, wherein:
the pushing and rotating assembly comprises at least one driving mechanism, and the driving mechanism comprises:
a driving motor; and
a transmission assembly connected with an output shaft of the driving motor and the push rod or the guide rod and configured to transmit a driving force provided by the driving motor to the push rod or the guide rod, such that the push rod is controllably extended and retracted, or the guide rod is controllably moved.

3: The automatic door opening and closing device for a refrigerator according to claim 2, wherein:
two driving mechanisms are provided, one driving mechanism is connected with the push rod and configured to drive the push rod to extend and retract, and the other driving mechanism is connected with the guide rod and configured to drive the guide rod to move.

4: The automatic door opening and closing device for a refrigerator according to claim 2, wherein:
the guide rod comprises:
a first guide portion having a first end fixedly connected to the driving mechanism and a second end outwards extending from the mounting space; and
a second guide portion having a first end relatively rotatably connected to the second end of the first guide portion and a second end fixedly connected to the door of the refrigerator.

5: The automatic door opening and closing device for a refrigerator according to claim 4, wherein:
the second end of the first guide portion is provided with a first assembling hole penetrating in a thickness direction thereof, and the first end of the second guide portion is provided with a second assembling hole penetrating in a thickness direction thereof;
the guide rod further comprises a rotating shaft portion having:
a rotation guide shaft assembled to the first assembling hole and the second assembling hole; and
an upper limit flange and a lower limit flange fixedly connected with the rotation guide shaft or integrated with the rotation guide shaft, and formed by outward radial extension from an upper section and a lower section of the rotation guide shaft respectively, such that the first guide portion and the second guide portion are relatively rotatably fitted over the rotation guide shaft.

6: The automatic door opening and closing device for a refrigerator according to claim 2, wherein:
the push rod is configured to controllably extend or retract along a direction of a central axis thereof, and the central axis of the push rod is parallel to a front-rear extending direction of the refrigerator; a rack arranged along the direction of the central axis of the push rod is formed on the push rod and configured to be in meshed connection with the driving mechanism.

7: The automatic door opening and closing device for a refrigerator according to claim 6, wherein:
the housing has a front wall and a back wall arranged opposite to each other, and the front wall is provided with a retractable hole in which the push rod is inserted and is retractably movable;
the pushing and rotating assembly further comprises:
a return elastic element connected between the back wall of the housing and the push rod and configured to drive the push rod to be retracted after the push rod is controllably extended.

8: The automatic door opening and closing device for a refrigerator according to claim 1, further comprising:
a turnover assembly provided outside the housing and comprising:
a turnover beam configured to be connected to the door of the refrigerator rotatably; and
a beam turnover mechanism comprising a turnover elastic assembly provided on the door of the refrigerator in a mode of reciprocating rotation around a shaft; wherein the turnover elastic assembly is configured to generate compression deformation by rotating around a shaft in a process of opening the door of the refrigerator, and release an elastic force by reversely rotating around the shaft to recover from the compression deformation in a process of closing the door of the refrigerator, such that the door of the refrigerator is driven to be closed, and the turnover beam is driven to be turned over in the process of closing the door of the refrigerator.

9: The automatic door opening and closing device for a refrigerator according to claim 8, wherein:
the beam turnover mechanism further comprises:
a cabinet fixed plate configured to be fixedly connected with a cabinet of the refrigerator; and
a turnover fixed shaft fixed above the cabinet fixed plate along a vertical direction; the turnover fixed shaft having an upper shaft section, a middle shaft section and a lower shaft section which are sequentially arranged from top to bottom; a rotating wheel radially extending outwards from the middle shaft section; an outer circumferential surface of the rotating wheel being provided with a wheel pit radially recessed inwards; and
the turnover elastic assembly comprises:
an elastic assembly assembling box having a plurality of assembling sections, the plural assembling sections comprising a first assembling section, a second assembling section and a third assembling section which are sequentially arranged along a horizontal direction, and the first assembling section being rotatably fitted over the upper shaft section and the lower shaft section, such that the turnover elastic assembly performs reciprocating rotation around the turnover fixed shaft; a guide shaft capable of reciprocating along an arrangement direction of the plural assembling sections being provided in the second assembling section; the third assembling section forming a retractable space;
a turnover elastic element retractably provided in the retractable space along the arrangement direction of the plural assembling sections and fixedly connected with the guide shaft; the guide shaft being provided with a protrusion matched with the wheel pit in shape, and the protrusion being configured to leave the wheel pit in the opening process of the door of the refrigerator, such that the turnover elastic element generates compression deformation; the protrusion being further configured to enter the wheel pit in the closing process of the door of the refrigerator, such that the turnover elastic element recovers from the compression deformation to release the elastic force.

10: A refrigerator, comprising:
a cabinet;
a door pivotally provided on the cabinet; and
an automatic door opening and closing device for a refrigerator according to claim 1.
